(19) United States
(12) Patent Application Publication
(10) Pub. No.: US 2026/0215897 A1
(43) Pub. Date: Jul. 30, 2026

(54) A HOLDER AND A HOLDER SYSTEM ASSEMBLY

(71) Applicant: ELOS MEDTECH PINOL A/S, Gørløse (DK)

(72) Inventors: Henrik ANDERSEN, Skibby (DK); Søren RANGSTRUP, Hørsholm (DK); Arvin Vali MAANI, København NV (DK); Brian Ravn JENSEN, Roskilde (DK)

(21) Appl. No.: 19/150,329

(22) PCT Filed: Feb. 5, 2024
(86) PCT No.: PCT/EP2024/052773

§ 371 Date: Jul. 23, 2025

(30) Foreign Application Priority Data
Feb. 7, 2023 (EP) 23155275.3

(51) Int. Cl. A61C 13/12; A61C 13/00

(52) U.S. Cl. CPC A61C 13/12; A61C 13/0022

(57) ABSTRACT

The invention relates to a holder for holding one or more pre-milled dental abutment blanks a holder assembly comprising a frame and the holder for use in a milling machine apparatus.

### FIELD OF THE INVENTION

The present invention relates to a holder for holding one or more pre-milled dental abutment blanks and to a holder system assembly to be used in a milling machine apparatus.

### BACKGROUND OF THE INVENTION

Pre-milled dental abutment blanks are generally machined in milling apparatus to produced dental abutments for dental applications.

To achieve effective milling, pre-milled dental abutment blanks are coupled to a retainer or a holder that secures a series of blanks that should undergo a milling process. The retainer or holder coupled to pre-milled dental abutment blanks is usually fasten to a frame within the milling apparatus before the automated milling process takes place.

Hence, an improved holder for holding one or more pre-milled dental abutment blanks and a holder system assembly to be used in a milling machine apparatus would be advantageous.

In particular, a holder allowing to align and fasten efficiently the holder within the frame despite the presence of debris would be advantageous.

### OBJECT OF THE INVENTION

An object of the present invention is to improve fitting of a holder of pre-milled dental abutment blanks within a holder system assembly.

A further object of the present invention is to provide a holder for holding one or more pre-milled dental abutment blanks having an improved stability when fasten to a frame within a holder system assembly.

An even further object of the invention may also be seen as to provide an alternative to current holder solutions.

In particular, it may be seen as an object of the present invention to provide a holder for holding one or more pre-milled dental abutment blanks which is able to achieve an optimal fitting within a frame of a holder system assembly by combining the presence of protrusions on at least two surfaces of the holder and of angulated tubular structures or channels allowing for fastening of the holder to a frame at a preferred angle.

### SUMMARY OF THE INVENTION

The above described object and several other objects are intended to be obtained in a first aspect of the invention by a holder for holding one or more pre-milled dental abutment blanks.

The holder has or comprises one or more holding channels for holding one or more pre-milled dental abutment blanks, which extend from a first surface to an opposite second surface of the holder.

The holder has or further comprises one or more angulated tubular structures or channels for clamping the holder into a frame of a holder system assembly.

In some embodiments, the one or more angulated tubular structures or channels are arranged in between the one or more holding channels along a longitudinal axis of the holder.

In some other embodiments, the holder comprises one holding channel arranged in between two or more angulated tubular structures.

The one or more angulated tubular structures or channels have an axial direction transverse with respect to the axial direction of the one or more holding channels and extend throughout the second surface of the holder.

The holder has, further comprises or is provided with one or more protrusions on one or more surfaces of the holder, such as at least on two surfaces of the holder, which are configured to be in contact with one or more surfaces of the frame, such as in contact with at least two surfaces of the frame.

The holder is suitable for holding and securing one or more pre-milled dental abutment blanks that have to be processed by a milling machine apparatus.

The holder is fasten to a frame of a holder system assembly during the milling process.

The holder may have different forms and shapes.

In some embodiments, the holder has a cuboid body, such as a substantially cuboid body.

Fastening of the holder to the frame of the holder system assembly is achieve through the presence of angulated tubular structures or channels and the use of clamping elements or screws.

The angulated tubular structures or channels have also openings on two different surfaces of the holder, i.e. the first or a third surface of the holder, so that a clamping elements or screw can be inserted into an opening on a surface and passing through the angulated tubular structures or channel reach the second surface and throughout the second surface reach a threaded recess within the frame.

The threaded recess within the frame is configured to engage with the fastening portion of the clamping elements or screw.

In some embodiments, the openings of the angulated tubular structures or channels are arranged in between the openings of the one or more holding channels along a longitudinal axis of the holder or in the longitudinal direction of the holder.

The angulated tubular structures or channels may also be referred herein as clamping tubular structures or channels as having the function of providing an angulated direction to the clamping elements or screws clamping or fastening the holder into the frame of the holder system assembly.

The angulated tubular structures may thus be referred to also as a through-holes allowing for the introduction, along an angulated direction, of clamping elements clamping or fastening the holder into the frame of the holder system assembly. The angulated tubular structures allow and ensure fastening of the holder against at least two surfaces of the frame, such as two intersecting surfaces, for example transversal surfaces or orthogonal surfaces, through the use of a single fastening or clamping element.

The one or more protrusions may be discontinuous, i.e. protrusions areas separated from each other, e.g. not a continuous ridge.

The one or more protrusions may be located on one or more surfaces of the holder, such as at least on two surfaces of the holder, for example on the second surface and on a side surface of the holder or on a bottom surface and on a side surface of the holder.

In some embodiments, the one or more protrusions may be located on three surfaces of the holder, such as on the second surface, on a side surface and on the bottom surface of the holder.

The one or more protrusions of the invention provide optimal fitting with the frame of a holder system assembly despite the possible presence of undesired particles on the frame surfaces.

Upon fastening of the holder onto the frame the one or more protrusions will be in contact with, such as rest against, one or more surfaces of the frame, such as at least in contact with at least two surfaces of the frame, for example in contact with three surfaces of the frame.

The one or more protrusions may be raised between 0.1 to 1 mm, such as 0.5 mm from the below holder surfaces.

In some embodiments, the one or more protrusions may be flat areas raised from the below holder surfaces of few tenth of a millimeter, such as 0.5 mm. This provides an optimal fit between the frame surfaces and the holder surfaces by allowing the presence of an air gap between the surfaces, thus the potential presence of undesired particles between the surfaces will not hinder the fastening process.

In some embodiments, the one or more protrusions may be at least two flat areas on at least two surfaces of the holder in contact with at least two surfaces of the frame.

In some further embodiments, the one or more protrusions may be at least two flat areas on three different surfaces of the holder in contact with three different surfaces of the frame.

Protrusions on the first surface of the holder, the first surface being the surface facing the pre-milled dental abutment blanks, may be present although having different functions than the one or more protrusions of the invention.

In some embodiments, the axial direction of the one or more angulated tubular structures or channels is at an angle between 80° and 10°, such as between 700 and 200, with respect to the axial direction of the one or more holding channels.

In some further embodiments, the axial direction of the one or more angulated tubular structures or channels is at an angle between 60° and 30°, such as at 45°, with respect to the axial direction of the one or more holding channels.

The specific inclination or angle of the angulated tubular structures or channels in combination with the one or more protrusion of the invention allows for optimal fit of the holder within the frame.

The inclination or an angle between 80° and 10°, being not orthogonal or parallel to the longitudinal axis of the holding channels, has the advantage of allow for fastening of the holder against two surfaces of the frame, thus improving the adhesion of the holder to the frame.

In some further embodiments, the holder further comprises one or more elongated protrusion elements.

In some embodiments, the one or more elongated protrusion elements are arranged in between the one or more protrusions.

The one or more elongated protrusion elements may be located on a bottom surface of the holder, being the bottom surface the surface opposite to the top surface, being the top surface the one comprising the one or more openings of the angulated tubular structures or channels.

The elongated protrusion elements provide support to the holder during the process of clamping and fastening the holder to the frame. The presence of the elongated protrusion elements is advantageous as the holder is generally fasten with the one or more pre-milled dental abutment blanks inserted within the holding channels, which may induce the holder to acquire a tilted position.

The one or more angulated tubular structures or channels are configured to receive one or more clamping elements or screws for clamping or fastening the holder into a frame of a holder system assembly.

The one or more holding channels have openings on two opposite surfaces of the 35 holder.

The openings, holes or apertures allow for insertion of the one or more pre-milled dental abutment blanks and thus are configured, as to size, shape and structure to receive the one or more pre-milled dental abutment blanks.

In particular, the one or more holding channels are configured to receive a fastening portion of the one or more pre-milled dental abutment blanks.

Fastening of the one or more pre-milled dental abutment blanks within the holder and within the one or more holding channels is achieved through the presence of angulated threaded channels and the use of securing screws.

In some embodiments, the holder further comprises one or more angulated threaded channels for securing the one or more pre-milled dental abutment blanks into the one or more holding channels.

The one or more angulated threaded channels have an axial direction transverse with respect to the axial direction of the one or more holding channels. The angulated threaded channels extend into the one or more holding channels, thereby allowing for securing or fastening the one or more pre-milled dental abutment blanks within the one or more holding channels.

The one or more angulated threaded channels have a first opening on a surface of the holder and a second opening into the one or more holding channels.

In some further embodiments, the one or more angulated threaded channels are configured to receive one or more securing screws for securing the one or more pre-milled dental abutment blanks to the holder.

A securing screw can be rotationally inserted into an opening of the one or more angulated threaded channels and thereby reach the one or more holding channels for securing or fastening the one or more pre-milled dental abutment blanks within the one or more holding channels.

The one or more angulated threaded channels for securing or fastening the one or more pre-milled dental abutment blank are configures to engage with the fastening portion of the securing screws.

The angulated threaded channels may also be referred herein as securing channels as having the function of providing an angulated direction to the securing screws securing or fastening the one or more pre-milled dental abutment blanks within the one or more holding channels.

The openings of the angulated threaded channels are arranged in alignment with the openings of the one or more holding channels along a longitudinal axis of the holder or in the longitudinal direction of the holder.

The securing screws have an ending portion configured to engage with the fastening portion of the one or more pre-milled dental abutment blanks.

In some embodiments, the axial direction of the one or more angulated threaded channels is at an angle between 90° and 100, such as between 70° and 20°, with respect to the axial direction of the one or more holding channels.

In some other embodiments, the axial direction of said one or more angulated threaded channels is at an angle between 60° and 300, such as at 45°, with respect to the axial direction of the one or more holding channels.

In some embodiments, the one or more angulated threaded channels comprise stopping means for stopping the one or more securing screws in a predetermined fastening direction, thereby avoiding undesired dropping of the one or more securing screws during operation.

The one or more angulated threaded channels may be configured to insert the one or more securing screws in one preferred direction, e.g. from the second surface or back surface towards another surface, such as a front surface, i.e. a surface that will not be facing any surface of the frame when fasten to the frame. The one or more angulated threaded channels may be configured to insert the one or more securing screws in one preferred direction due to the presence of a zero pitch revolution at one opening of the one or more angulated threaded channels allowing to stop the rotation of the securing screw in one preferred direction This feature has the advantage of avoiding undesired loss of the securing screws during operation. Once the securing screws are inserted in the one or more angulated threaded channels through the back surface of the holder and the holder is fasten to the frame, the securing screws cannot be removed from the one or more angulated threaded channels unless the holder is detached from the frame.

In some embodiments, the one or more holding channels further comprise one or more positioning elements configured to retain the one or more pre-milled dental abutment blanks in a rotationally secured manner.

The one or more positioning or aligning elements are located within the one or more holding channels. The one or more positioning or aligning elements may be fasten or milled within the one or more holding channels.

In some embodiments, the one or more pre-milled dental abutment blanks have a cylindrical central portion and a pin shaped fastening portion provided with at least a first recess configured to engage with said one or more securing screws and with at least a second recess configured to engage with said one or more positioning or aligning elements.

The pin shaped fastening portion has a diameter allowing for insertion into one opening of the one or more holding channels.

In a second aspect, the invention relates to a holder system assembly, for a milling machine apparatus or device, comprising a holder, according to the first aspect of the invention and a frame, wherein the holder is fasten to the frame.

The first, second and other aspects and embodiments of the present invention may each be combined with any of the other aspects and embodiments. These and other aspects and embodiments of the invention will be apparent from and elucidated with reference to the embodiments described hereinafter.

### BRIEF DESCRIPTION OF THE FIGURES

The holder and the holder assembly according to the invention will now be described in more details with regard to the accompanying figures. The figures show one way of implementing the present invention and are not to be construed as being limiting to other possible embodiments falling within the scope of the attached claim set.

FIG. 1 shows a 3D schematic front view of a holder according to some embodiments of the invention.

FIG. 2 shows a further 3D schematic bottom view of a holder according to some embodiments of the invention.

FIG. 3 shows a schematic front view focused on a first surface of a holder according to some embodiments of the invention.

FIG. 4 shows a schematic front view focused on a second surface opposite to the first surface of a holder according to some embodiments of the invention.

FIG. 5 shows a 3D schematic view of a frame for a holder system assembly according to some embodiments of the invention.

FIG. 6 shows a 3D schematic view of a holder system assembly according to some embodiments of the invention.

FIG. 7 shows a 3D schematic view of a holder holding three pre-milled dental abutment blanks according to some embodiments of the invention.

FIG. 8 is a cross section of a holder holding a pre-milled dental abutment blank comprising a securing screw, according to some embodiments of the invention.

FIG. 9 is a cross section of a holder holding a pre-milled dental abutment blank according to some embodiments of the invention.

FIG. 10 shows a 3D schematic view of pre-milled dental abutment blanks.

FIG. 11 shows a further 3D schematic view of pre-milled dental abutment blanks.

FIG. 12 shows a 3D schematic front view of a holder according to some embodiments of the invention in which the holder comprises one holding channel arranged in between two angulated tubular structures.

### DETAILED DESCRIPTION OF SOME EMBODIMENTS

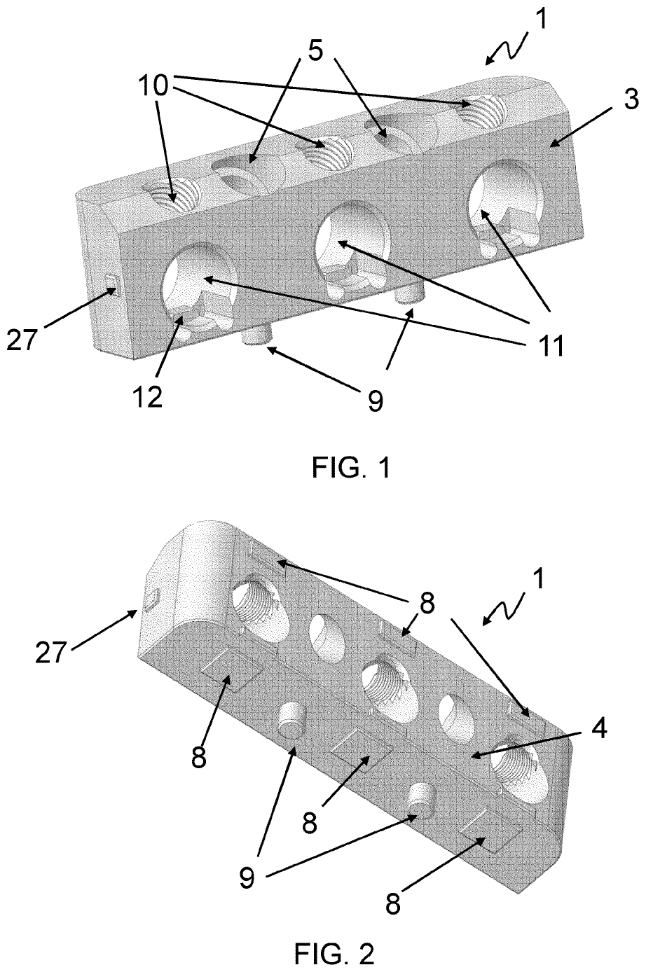

FIGS. 1 and 2 show a 3D schematic front view of a holder 1 for holding one or more pre-milled dental abutment blanks.

The holder comprises three holding channels 11 extending from a first surface 3 to an opposite second surface 4.

The three holding channels show also the presence of aligning elements 12. FIGS. 1 and 2 show also the presence of two angulated tubular structures or channels 5 for clamping or fastening the holder 1 into a frame.

From FIGS. 1 and 2 it appears clear the inclination of the two angulated tubular structures or channels, being in the specific embodiment, at 45° with respect to the axial direction of the three holding channels 11.

FIGS. 1 and 2 also show an example of the protrusions 8 of the invention located on different surfaces of the holder 1.

The protrusions 8 provide optimal fitting with the frame of a holder system assembly despite the possible presence of undesired particles on the frame surfaces. Upon fastening of the holder onto the frame the protrusions 8 will be in contact with, such as rest against, one or more surfaces of the frame. The two angulated tubular structures or channels 5 for clamping or fastening the holder 1 into a frame have an inclination with respect to the axial direction of the holding channels 11 allowing for fastening of the holder against at least two surfaces of the frame, via contact through protrusions 8, by using a fastening or clamping element.

Further protrusions, such as protrusions 27 may be present on other surfaces of the holder 1.

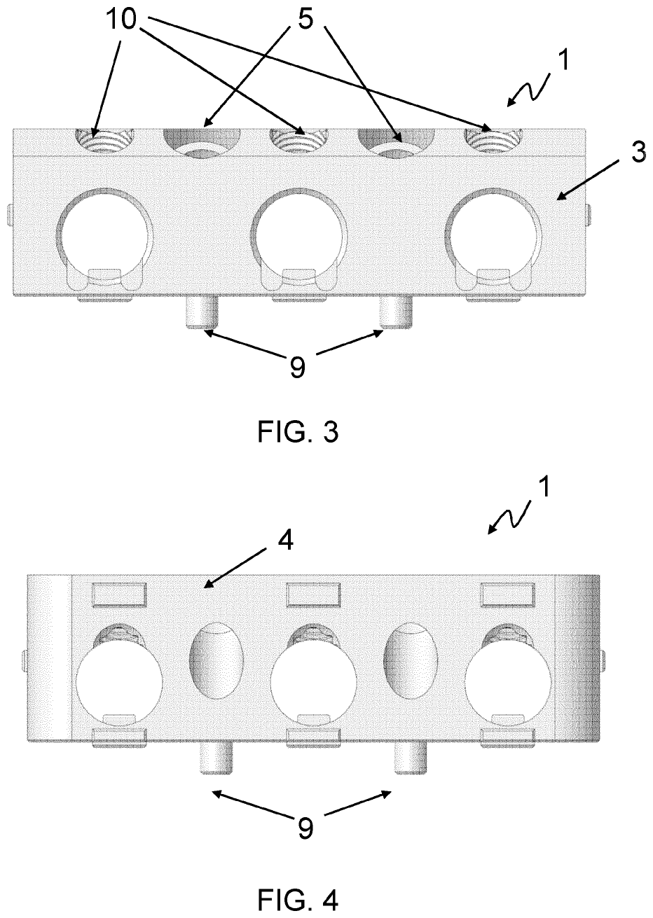

FIGS. 3 and 4 show a schematic front view of the first surface 3 and the surface 4 of holder 1. It can be noticed the presence of two elongated protrusion elements 9.

FIGS. 1-4 show also the presence of three angulated threaded channels 10.

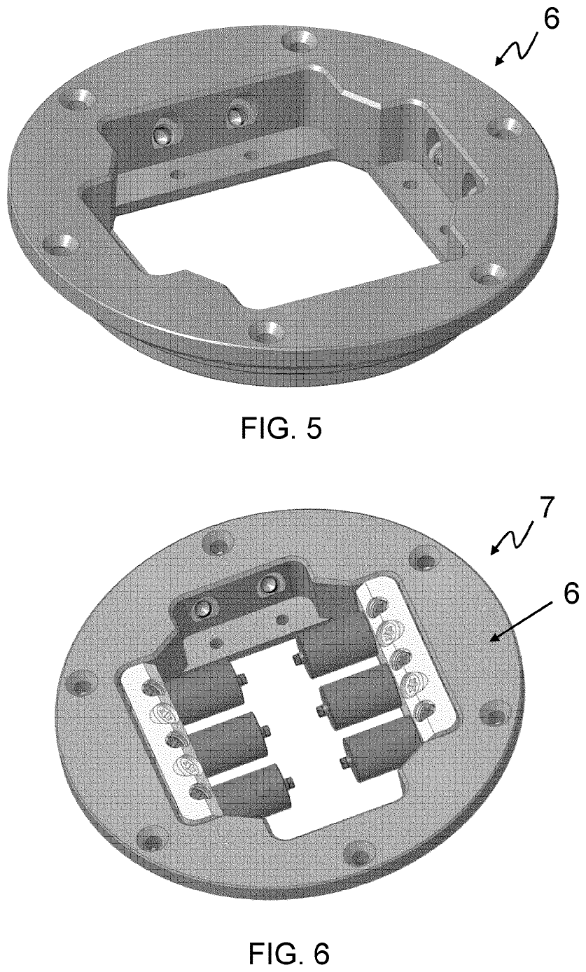

FIG. 5 shows a 3D schematic view of a frame 6 for a holder system assembly.

FIG. 6 shows a 3D schematic view of a holder system assembly 7 including the frame 6 and a holder comprising pre-milled dental abutment blanks.

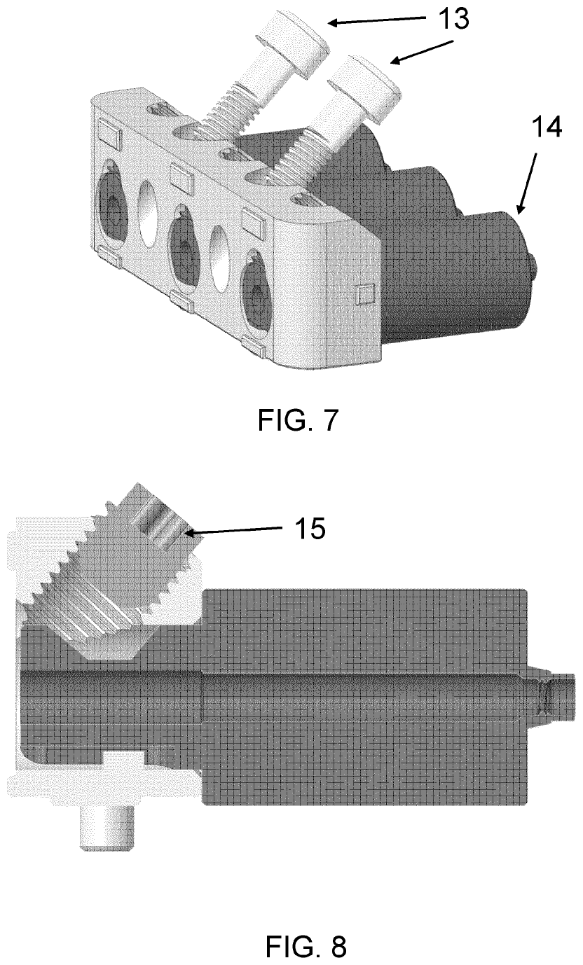

FIG. 7 shows a 3D schematic view of a holder holding three pre-milled dental abutment blanks 14 while two clamping elements or screws are inserted at a 45° angle with respect to the axial direction of the three holding channels.

FIG. 8 is a cross section of a holder holding a pre-milled dental abutment blank 14 comprising a securing screw 15 in position.

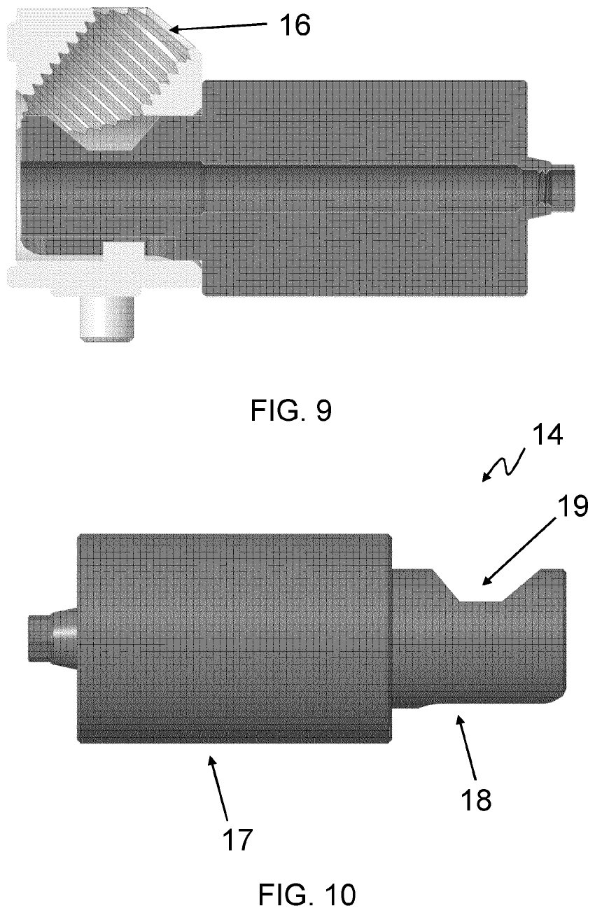

FIG. 9 is a cross section of a holder holding a pre-milled dental abutment blank showing the presence of a thread with a zero pitch revolution 16 having the function of stopping means for stopping the securing screw.

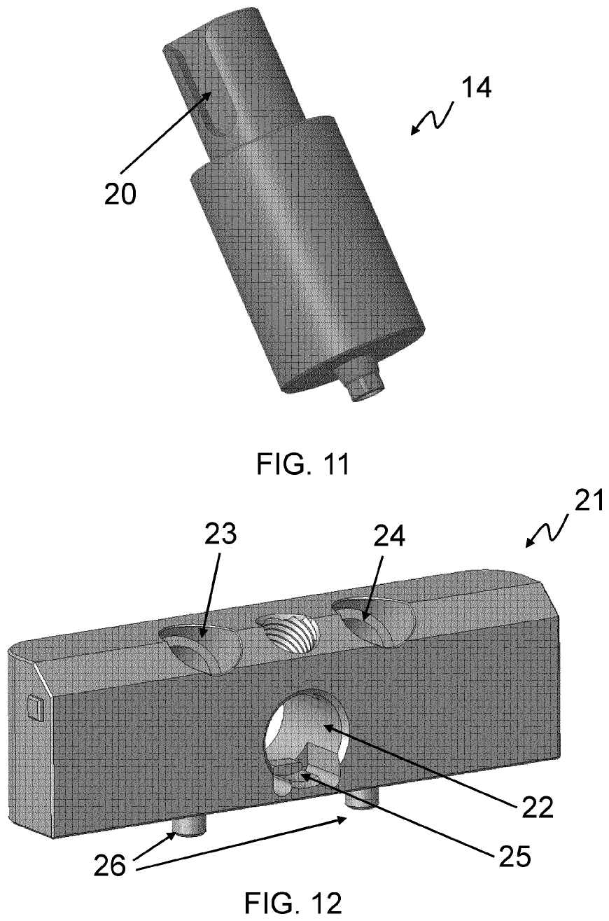

FIG. 10 shows a 3D schematic view of a pre-milled dental abutment blank 14 having a cylindrical central portion 17 and a pin shaped fastening portion 18 provided with a recess 19 configured to engage with the securing screw and a second recess 20, showed in FIG. 11, configured to engage with the aligning element 12, showed in FIG. 1.

FIG. 12 shows a 3D schematic front view of a holder 21 comprising one holding channel 22 for holding one pre-milled dental abutment blank arranged in between two angulated tubular structures or channels 23 and 24.

The holding channel 22 extends from a first surface to an opposite second surface.

The holding channel may comprise, as shown an aligning elements 25.

The two angulated tubular structures or channels 23 and 24 for clamping or fastening the holder 21 into a frame have an inclination with respect to the axial direction of the holding channel allowing for fastening of the holder against at least two surfaces of the frame, through the use of a single fastening or clamping element.

Protrusions 26 may be present and located on different surfaces of the holder 21.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1-15. (canceled)

16. A holder for holding one or more pre-milled dental abutment blanks, said holder comprising one or more holding channels for holding said one or more pre-milled dental abutment blanks;
said one or more holding channels extending from a first surface to an opposite second surface of said holder;
said holder further comprising one or more angulated tubular structures for clamping said holder into a frame of a holder system assembly;
said one or more angulated tubular structures having a longitudinal axial direction being transverse with respect to the axial direction of said one or more holding channels;
said one or more angulated tubular structures extending throughout said second surface of said holder;
said holder further comprising one or more protrusions on one or more surfaces of said holder,
said one or more protrusions configured to be in contact with one or more surfaces of said frame,
wherein said longitudinal axial direction of said one or more angulated tubular structures is at an angle between 80° and 10°, with respect to the axial direction of said one or more holding channels.

17. A holder, according to claim 16, wherein said axial direction of said one or more angulated tubular structures is at an angle between 60° and 30°, with respect to the axial direction of said one or more holding channels.

18. A holder, according to claim 16, wherein said holder has a cuboid body.

19. A holder, according to claim 16, wherein said holder further comprises one or more elongated protrusion elements.

20. A holder, according to claim 19, wherein said one or more elongated protrusion elements are arranged in between said one or more protrusions.

21. A holder, according to claim 16, wherein said one or more angulated tubular structures are configured to receive one or more clamping screws.

22. A holder, according to claim 16, said holder further comprising one or more angulated threaded channels for securing said one or more pre-milled dental abutment blanks into said one or more holding channels;
said one or more angulated threaded channels having an axial direction being transverse with respect to the axial direction of said one or more holding channels;
said angulated threaded channels extending into said one or more holding channels.

23. A holder according to claim 22, wherein said axial direction of said one or more angulated threaded channels is at an angle between 90° and 10°, with respect to the axial direction of said one or more holding channels.

24. A holder, according to claim 22, wherein said axial direction of said one or more angulated threaded channels is at an angle between 60° and 30°, with respect to the axial direction of said one or more holding channels.

25. A holder, according to claim 22, wherein said one or more angulated threaded channels are configured to receive one or more securing screws for securing said one or more pre-milled dental abutment blanks to said holder.

26. A holder, according to claim 25, wherein said one or more angulated threaded channels comprise stopping means for stopping said one or more securing screws in a predetermined fastening direction.

27. A holder, according to claim 16, wherein said one or more holding channels further comprise one or more positioning elements configured to retain said one or more pre-milled dental abutment blanks in a rotationally secured manner.

28. A holder, according to claim 27, wherein said one or more pre-milled dental abutment blanks have a cylindrical central portion and a pin shaped fastening portion provided with at least a first recess configured to engage with said one or more securing screws and with at least a second recess configured to engage with said one or more positioning elements.

29. A holder, according to claim 16, wherein said one or more angulated tubular structures are arranged between two of said one or more holding channels along a longitudinal axis of said holder.

30. A holder system assembly, comprising:
a frame; and
a holder, according to claim 1, wherein said holder is fasten to said frame.
